(19) United States
(12) Patent Application Publication
(10) Pub. No.: US 2009/0300319 A1
(43) Pub. Date: Dec. 3, 2009

(54) APPARATUS AND METHOD FOR MEMORY STRUCTURE TO HANDLE TWO LOAD OPERATIONS

(76) Inventors: Ehud Cohen, Kiryat Motskin (IL); Omer Golz, Haifa (IL); Oleg Margulis, Haifa (IL)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/131,742

(22) Filed: Jun. 2, 2008

(51) Int. Cl. G06F 12/10

(52) U.S. Cl. 711/207; 711/206; 711/E12.058; 711/E12.061

(57) ABSTRACT

An apparatus and method to increase memory bandwidth is presented. In one embodiment, the apparatus comprises a load array having: a first array to store a plurality of load operation entries and a second array to store a second plurality of load operation entries. The apparatus further comprises: a store array having a plurality of store operation entries; a first address generation unit coupled to send a linear address of a first load operation to the first array and to send a linear address of a first store operation to the store array; and a second address generation unit coupled to send a linear address of a second load operation to the second array and to send a linear address of a second store operation to the store array.

### FIELD OF THE INVENTION

Embodiment of the invention relate to array structure and port structure of computer memory system that can handle two load operations concurrently.

### BACKGROUND OF THE INVENTION

A computer system may be divided into three basic blocks: a central processing unit (CPU), memory, and input/output (I/O) units. These blocks are coupled to each other by a bus. An input device, such as a keyboard, mouse, stylus, analog-to-digital converter, etc., is used to input instructions and data into the computer system via an I/O unit. These instructions and data can be stored in memory. The CPU receives the data stored in the memory and processes the data as directed by a set of instructions. The results can be stored back into memory or outputted via the I/O unit to an output device, such as a printer, a display unit (CRT or LCD) display, digital-to-analog converter, etc.

The CPU receives data from memory as a result of performing load operations. Each load operation is typically initiated in response to a load instruction. The load instruction specifies an address to the location in the memory at which the desired data is stored. The load instruction also specifies the amount of data that is desired. Using the address and the amount of data specified, the memory may be accessed and the desired data obtained.

Data is stored back into memory as a result of the computer system performing a store operation. A store operation includes an address calculation and a data calculation. The address calculation generates the address of the memory location at which the data is going to be stored. The data calculation produces the data that is going to be stored at the address generated in the address calculation portion of the store operation. These two calculations are performed by different hardware in the computer system and require different resources. In the prior art, a processor upon receiving the store operation produces two micro-operations, referred to as the store data (STD) and the store address (STA) operations. These micro-operations correspond to the data calculation and address calculation sub-operations of the store operation respectively. The processor then executes the STD and STA operations separately. Upon completion of the execution of the STD and STA operations, their results are combined and ready for dispatch to a cache memory or a main memory.

Some computer systems have the capabilities to execute instructions out-of-order. In other words, the CPU in a computer system is capable of executing one instruction before a previously issued instruction is completed. Special considerations exist with respect to performing memory operations out-of-order in a computer system. In prior art, a store array and a load array are incorporated in a computer system as part of the solution to resolve data dependency conflicts that occurs during out-of-order execution. A load array contains information associated with load operations; a store array contains information associated with store operations dispatched from instruction fetch unit.

Memory access operations, for example the load and store operations described above, are among the biggest performance bottleneck in a computer system. Slow memory access can penalize the performance of computer systems severely. Attempt to improve the computer system by various enhancement features might fail, if performed without sufficient memory bandwidth for their support.

### BRIEF DESCRIPTION OF THE DRAWINGS

The present invention is illustrated by way of example and is not limited by the figures of the accompanying drawings, in which like references indicate similar elements, and in which:

FIG. 1 is a simplified view of a memory subsystem of a computer system.

FIG. 2 shows a high level description of internal arrays and ports within a memory execution unit.

FIG. 3 shows embodiment of a multi-banked structure in a cache.

FIG. 4 shows an embodiment of a load array structure.

FIG. 5 shows an embodiment of a load array structure for a multi-threading system.

FIG. 6 illustrates a computer system in which one embodiment of the invention may be used.

FIG. 7 illustrates a point-to-point computer system in which one embodiment of the invention may be used.

### DETAILED DESCRIPTION OF THE INVENTION

Embodiments of a method and apparatus for computer memory system are described. In the following description, numerous specific details are set forth. However, it is understood that embodiments may be practiced without these specific details. In other instances, well-known elements, specifications, and protocols have not been discussed in detail in order to avoid obscuring the present invention.

A memory execution unit is a part of an execution unit that responsible to execute various memory access operations (e.g., load and store operations) in a processor. The memory execution unit receives load and store operations from a scheduler and executes them to complete the memory access operations. In one embodiment, a memory execution unit comprises a load array, a store array, a translation lookaside buffer, and a data cache. The components communicate with each others through ports. Each port may include control signals, data signals, and/or status signals. In one embodiment, dispatching an operation means sending in any combination of the following: the address or addresses of the operands, status information of the operation, code associated with the operation, code indicating operands for the operations, etc. The implementations of different port structure designs can determine the memory bandwidth available between the scheduler and the data cache.

Using a new port structure design to increase memory bandwidth triggers various physical design considerations (e.g., area of design) as well as performance considerations. Balancing between the two factors is important to ensure that the area of the design is kept within a manageable size and still enables the design to enjoy the performance benefit by having additional bandwidth accessing a data cache.

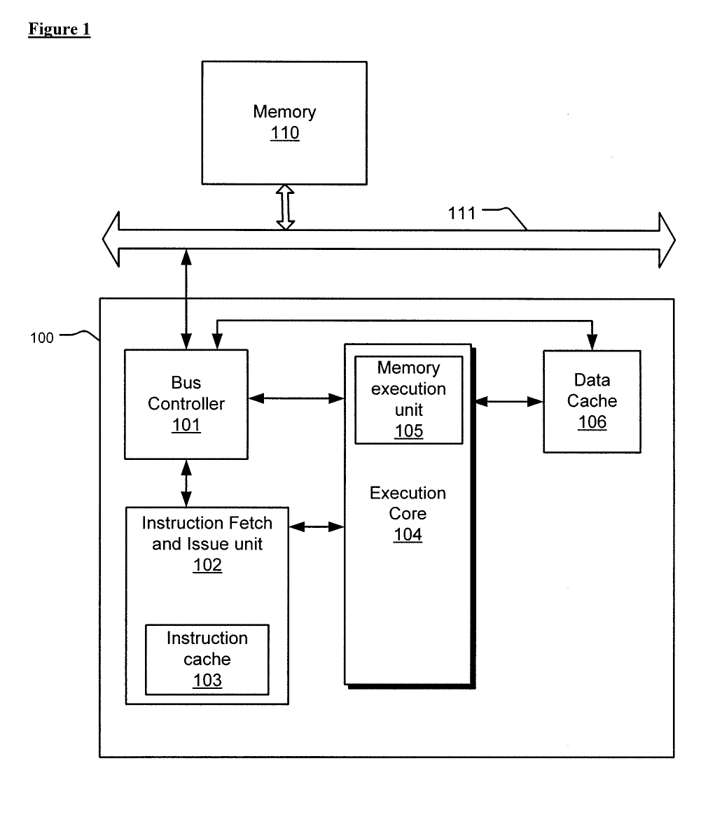

FIG. 1 is a block diagram of a memory subsystem of a computer system. Referring to FIG. 1, the memory subsystem comprises an instruction fetch and issue unit 102 with integrated instruction cache 103, execution core 104 with memory execution unit 105, bus controller 101, data cache memory 106, memory unit 110, and bus 111.

The memory unit 110 is coupled to the system bus. The bus controller 101 is coupled to bus 111. The bus controller 101 is also coupled to data cache memory 106 and instruction fetch and issue unit 102. The instruction fetch and issue unit 102 is also coupled to execution core 104. The execution core 104 is also coupled to data cache memory 106. In this embodiment, instruction fetch and issue unit 102, execution core 104, bus controller 101, and data cache memory 106 together constitute parts of processing mean 100. In this embodiment, elements 101-106 cooperate to fetch, issue, execute and save the execution results of instructions in a pipelined manner.

The instruction fetch and issue unit 102 fetches instructions from an external memory, such as memory unit 110, through the bus controller 101 via bus 111, or any other external bus. The fetched instructions are stored in instruction cache 102. The bus controller 101 manages cache coherency transfers. The instruction fetch and issue unit 102 issues these instructions in order to execution core 104. The execution core 104 performs arithmetic and logic operations, such functions as add, subtract, logical AND, and integer multiply, as well as memory operations. In one embodiment, execution core 104 also includes memory execution unit 105 that holds, executes and dispatches load and store operations to data cache memory 106 (as well as external memory) as soon as their operand dependencies on execution results of preceding instructions are resolved.

Bus controller 101, bus 111, and memory 110 are intended to represent a broad category of these elements found in most computer systems. Their functions and constitutions are well-known and will not be described further. The execution core 104, incorporating with an embodiment of the present invention, and the data cache memory 106 will be described further in detail below with additional references to the remaining figures.

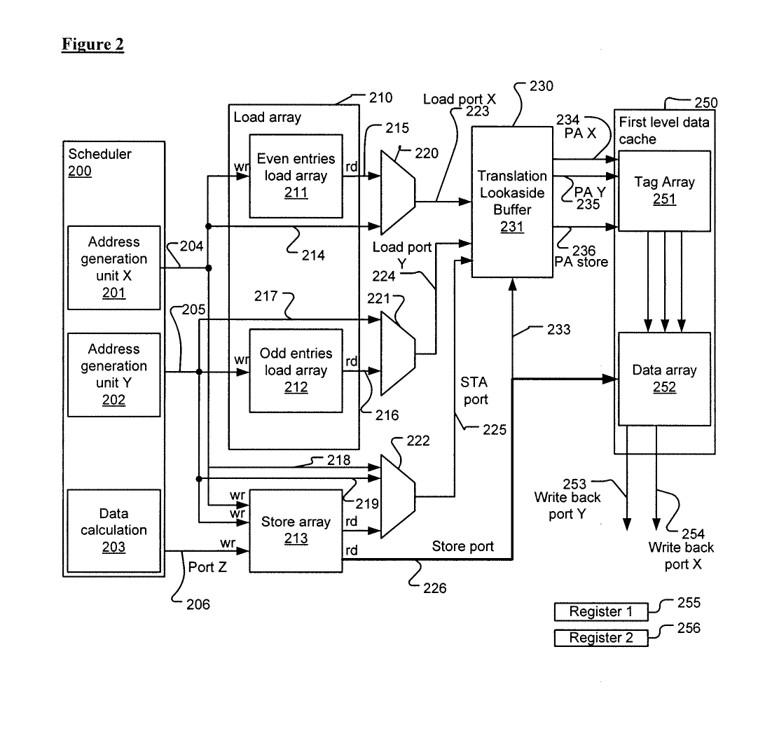

FIG. 2 shows a high level description of internal arrays and ports in a memory execution unit and a data cache. Referring to FIG. 2, the memory execution unit comprises scheduler 200, load array 210, store array 213, and translation lookaside buffer (TLB) 231. The memory execution unit is coupled to data cache 250. In one embodiment, scheduler 200 further comprises, but is not limited to, address generation unit X 201, address generation unit Y 202, and data calculation unit 203. In this embodiment, load array comprises even entries array 211 and odd entries array 212. In one embodiment, data cache 250 comprises data array 252 and tag array 251. Data array 252 can include fill buffers that are well-known in the art.

In one embodiment, address generation unit X 201 is coupled to even entries array 211, arbiter 220, arbiter 222, and store array 213 via linear address port X 204. Address generation unit Y 202 is coupled to odd entries array 212, arbiter 221, arbiter, 222, and store array 213 via linear address port Y 205. Data calculation unit 203 is coupled to store array 213 via port Z 206 to provide data corresponding to store operations.

In this embodiment, even entries array 211 is coupled to arbiter 220, odd entries array 212 is coupled to arbiter 221. Store array 213 is coupled to arbiter 222. Arbiter 220, arbiter 221, and arbiter 222 are coupled to TLB 213 via load port X 223, load port Y 224, and STA port 225 respectively. In addition to that, store array is also coupled to TLB 231 and data array 252 through Store port 226.

In one embodiment, tag array 251 of data cache 250 is coupled to TLB 231 through three physical address ports (i.e. physical address port X 234, physical address port Y 235, and physical address port store 236). In one embodiment, data array 252 of data cache 250 can be coupled to a plurality of registers (e.g., 255, 256) to write the results of load operations using write back port X 254 and write back port Y 253. The physical address ports (e.g. 234, 235, and 236) for accessing data cache 250 are important to increase the bandwidth accessing data cache 250.

In one embodiment, load array 210 and store array are used to store in-flight load operations and store operations that have not been retired in a pipeline. In one embodiment, load array 210 and store array 213 are used in an out-of-order micro-architecture to resolve data dependency conflict such as read-after-write (RAW) data conflict. Moreover, for the purpose of load consistency and memory reordering, the memory operations are maintained to a late point of the retirement stage in some embodiment to conform to the conventional X86 architecture. Scheduler 200 dispatches the operations into the memory system when all sources of data required are ready.

In one embodiment, address generation unit X 201 and address generation unit Y 202 calculate linear addresses of load operations and store operations. Load operations and store operations can be dispatched using either address generation unit X 201 or address generation unit Y 202. The two ports (i.e. 204, 205) are shared to dispatch addresses for load operations and store operations. In one embodiment, the scheduler 200 uses a load balancing algorithm to attempt to have the two ports be used equally by all the memory operations (including load and store operations).

In one embodiment, a load operation is allocated to an address generation unit (either address generation unit X 201 or address generation unit Y 202). In one embodiment, load array 210 is split into two arrays, namely even entries array 211 and odd entries array 212. Each array has a single write port. If a load operation is allocated to address generation unit X 201, the entry of the operation is dispatched through linear address port X 204. In one embodiment, a specific set of conditions (e.g., blocking status condition, address conflict information and prioritization information) is used to determine whether a load operation is allowed to continue in execution. If the load operation is blocked from immediate execution, it is stored in even entries array.

On the other hand, if a load operation entry is allocated to address generation unit Y 202, the entry of the operation is dispatched through linear address port Y 205. If the load operation is blocked based on conditions as described above, the entry of the operation is stored in odd entries array 211.

In one embodiment, scheduler 200 binds store operations to either of the ports (i.e., 204, 205) based on a load balancing algorithm. Addresses for store operations are dispatched via linear address port 204 and linear address port 205. Store operations, if blocked, are stored in store array 213. Addresses for store operations are dispatched to linear address port X 204 or linear address port Y 205 regardless of their location in the store array 213. In one embodiment, store array 213 is dual ported and two addresses can be written thereto from address generation unit X 201 and address generation unit Y 202 during a clock cycle.

In one embodiment, arbiter 222 selects store addresses from linear address port 204, linear address port 205, and store array 213 to send the addresses for store operations to TLB 231 via STA port 225. Physical addresses for store operations are subsequently dispatched from TLB 231 to data cache 250 using a dedicated port: physical address (PA) store port 236. In one embodiment, store array 213 has a dedicate port 206 to receive store data from data calculation unit 203. Data for stores operations are sent into TLB 213 and to data cache 250 via store port 226.

Load operations are dispatched from load array 210 to TLB 231 with two dedicated ports (i.e., load port X 223 and load port Y 224). All load operations dispatched from address generation unit X 201 or stored in even entries array 211 are dispatched on load port X 223. Arbiter 220 selects one load operation at a time from even entries array 211 and linear address port X 204 of scheduler 200. All load operations in odd entries array 212 are dispatched on load port Y 224. Arbiter 221 selects one load operation at a time from odd entries array 212 and linear address port Y 205 of scheduler 200. The load array 210 therefore has two read ports, one for each half of load array 210.

TLB 231 includes three ports (load port X 223, load port Y 224, and STA port 225) to receive addresses from the arbiters (220, 221, and 222). Each of the ports is a non-shared port (not being shared between store and load operations) and each port is connected to specific hardware implementations. In one embodiment, TLB 213 translates a linear address into a physical address in a manner well-known in the art. A linear address comprises two parts, a page reference and an offset. A physical address comprises of two parts, which is a page address and an offset. The generated physical addresses are sent to data cache 250 via physical address port X 234, physical address port Y 235, and physical address store port 236.

In one embodiment, data cache 250 can handle two load operations and one store operation in every clock. Tag array 251 and data array 252 are triple ported. Tag array 251 contains the address and state of each line stored in the data array 252. To serve two load operations and one store operation in every clock cycle, tag array 251 has three physical ports. The ports are non-shared ports. Data array 252 contains data portion of copies of lines of main memory. Structure of data array 252 will be described further in detail below with addition references to remaining figures. In one embodiment, register 255 and register 256 are coupled to receive results from data array 252 via write back port X 254 and write back port 253. In one embodiment, write back port X sends the results of load operations dispatched through address generation unit X 201, while write back port Y sends the results of load operations dispatched through address generation unit Y 202.

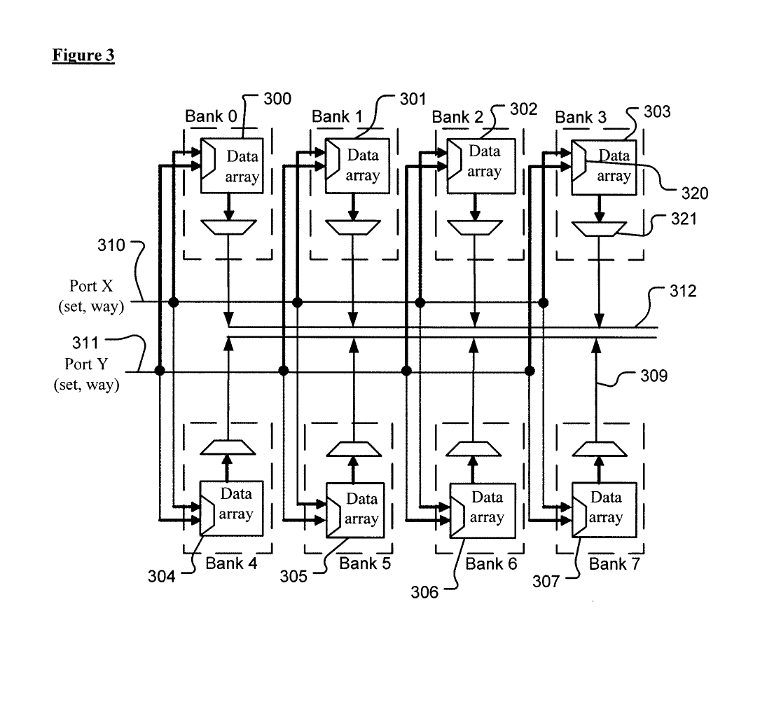

FIG. 3 shows an embodiment of multi-banked structure for a data array of a cache. Referring to FIG. 3, the multi-banked structure handles two load operations simultaneously providing that the two load operations are not accessing the same bank. Other well-known elements in a data array (such as, a port for store operations) have not been included to avoid obscuring the embodiment of the invention. Referring to FIG. 3, the data array comprises port X 310, port Y 311, eight memory banks (300-307), and write back bus 312. The number of memory banks can vary in other embodiments (such as, 8, 16, and 32 memory banks).

To handle two load operations and one store operation in one clock cycle, the data array implements a bank conflict check (not shown in figure) between the two load operations in which the two load operations can complete only if they are trying to access different memory banks. In one embodiment, load operations that cannot be completed because of memory bank conflict will be re-dispatched or replayed. Two addresses are sent to each memory bank using either port X 310 or port Y 311. A multiplexer (e.g., 320) in each memory bank selects one of the addresses. This address is decoded and the data is read from the location referenced by this address in all the ways in the memory bank. In one embodiment, each memory banks comprises 8 ways (not shown in the figure). In other embodiment, the memory banks can comprises different number of ways. Way-select multiplexers (e.g., 321) select one of the ways and subsequently drive the resultant data from a load operation to the write back bus 312. The write back bus 312 is coupled to write back port X 253 and write back port Y 254 of FIG. 2. Since each one of the two addresses is selected locally within a memory bank, two load operations can be served in one clock cycle. For example, if port X 310 needs to read from memory bank 0 and port Y 311 needs to read from memory bank 4, memory bank 0 will decode the address from port X 310 address, while memory bank 4 will decode the address from port Y 311.

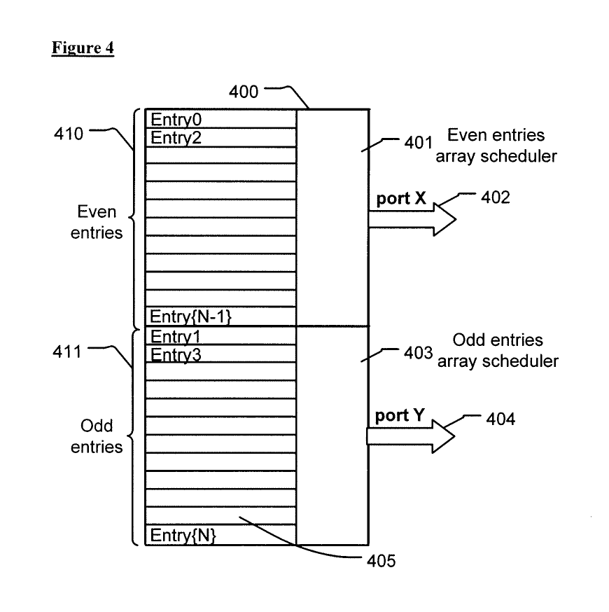

FIG. 4 shows one embodiment of a load array structure. Referring to FIG. 4, the load array structure comprises of a plurality of load operation entries (e.g., 405). Load array is divided into two sections, namely even entries array 410 and odd entries array 411. Even entries array 410 stores load operations in even numbered entries such as Entry 0, Entry 2, and others. Odd entries array 411 stores load operations in odd numbered entries such as Entry 1, Entry 3, and so on. Each array has its scheduler and a dedicated read port. For example, even entries array 410 has even entries array scheduler 401, and a load address is dispatched via a dedicated port X 402. The load array structure can have a different number of sections can be different in various embodiments to cater for different configurations.

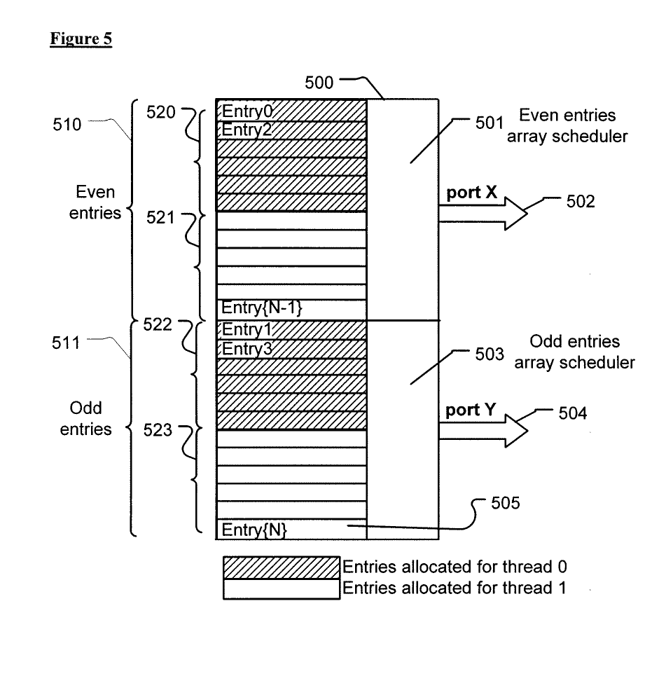

FIG. 5 shows one embodiment of a load array structure for a multi-threading computer system. Referring to FIG. 5, the load array structure 500 comprises a plurality of load operation entries 505. Load array 500 is divided into two sections, namely even entries array 510 and odd entries array 511. Each section is further divided into sub-sections (e.g., 520, 521, 522, and 523). In one embodiment, a multi-threading processor splits out-of-order resources between the two threads. Load array entries are statically split for the two threads (thread 0 and thread 1). In this embodiment, load operations of thread 0 use subsections 520 and 522, as indicated with cross hatching in FIG. 5. Load operations of thread 1 uses the subsections, e.g., 521, 523, as in FIG. 5 without cross hatching. With the load array structure in FIG. 5, each thread can utilize the two ports (e.g., 502, 504). Such an implementation can allow increased usage of all memory ports. In one embodiment, embodiments of FIG. 4 and FIG. 5 are used together in conjunction with simultaneous multi-threading processors (SMT) or multi-threading computer systems.

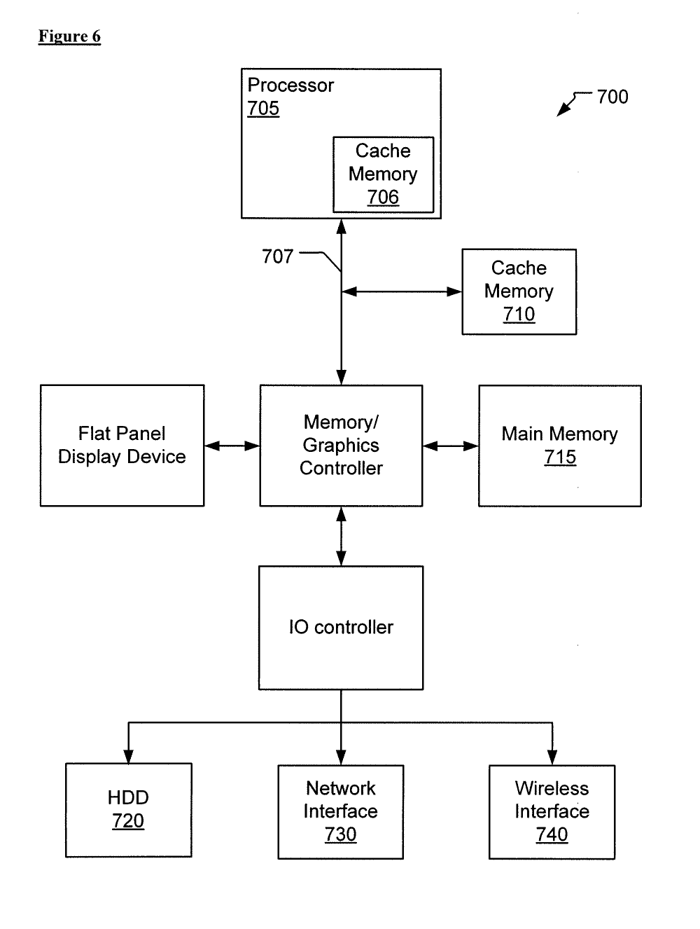

FIG. 6, for example, illustrates a front-side-bus (FSB) computer system in which one embodiment of the invention may be used. A processor 705 accesses data from a level 1 (L1) cache memory 706, a level 2 (L2) cache memory 710, and main memory 715. In one embodiment, processor 705 comprises at least an embodiment of the invention to support execution of memory operations. In other embodiments, the cache memory 706 may be a multi-level cache memory comprise an L1 cache together with other memory such as an L2 cache. Furthermore, in other embodiments, the computer system may have the cache memory 710 as a shared cache for more than one processor core.

The processor 705 may have any number of processing cores. Other embodiments of the invention, however, may be implemented within other devices within the system or distributed throughout the system in hardware, software, or some combination thereof.

The main memory 710 may be implemented in various memory sources, such as dynamic random-access memory (DRAM), a hard disk drive (HDD) 720, or a memory source located remotely from the computer system via network interface 730 or via wireless interface 740 containing various storage devices and technologies. The cache memory may be located either within the processor or in close proximity to the processor, such as on the processor's local bus 707. Furthermore, the cache memory may contain relatively fast memory cells, such as a six-transistor (6T) cell, or other memory cell of approximately equal or faster access speed.

Other embodiments of the invention, however, may exist in other circuits, logic units, or devices within the system of FIG. 6. Furthermore, in other embodiments of the invention may be distributed throughout several circuits, logic units, or devices illustrated in FIG. 6.

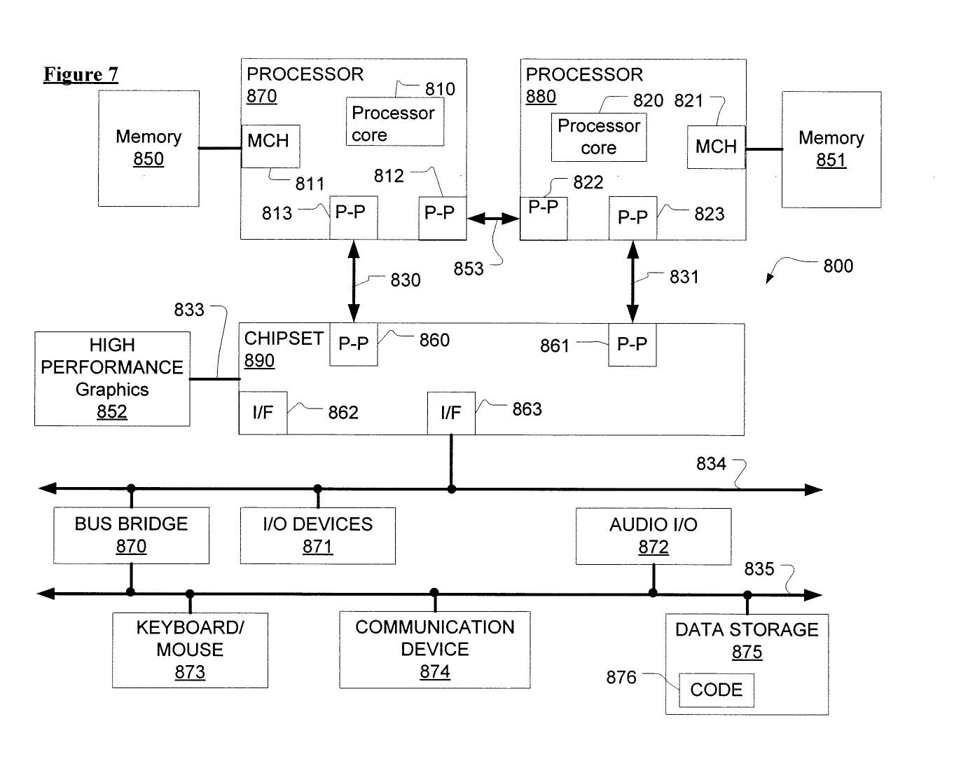

Similarly, at least one embodiment may be implemented within a point-to-point computer system. FIG. 7, for example, illustrates a computer system that is arranged in a point-to-point (PtP) configuration. In particular, FIG. 7 shows a system where processors, memory, and input/output devices are interconnected by a number of point-to-point interfaces.

The system of FIG. 7 may also include several processors, of which only two, processors 870, 880 are shown for clarity. Processors 870, 880 may each include a local memory controller hub (MCH) 811, 821 to connect with memory 850, 851. Processors 870, 880 may exchange data via a point-to-point (PtP) interface 853 using PtP interface circuits 812, 822. Processors 870, 880 may each exchange data with a chipset 890 via individual PtP interfaces 830, 831 using point to point interface circuits 813, 823, 860, 861. Chipset 890 may also exchange data with a high-performance graphics circuit 852 via a high-performance graphics interface 862. Embodiments of the invention may be located within any processor having any number of processing cores, or within each of the PtP bus agents of FIG. 7.

Other embodiments of the invention, however, may exist in other circuits, logic units, or devices within the system of FIG. 7. Furthermore, in other embodiments of the invention may be distributed throughout several circuits, logic units, or devices illustrated in FIG. 7.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A memory apparatus comprising
a load array having:
a first array to store a first plurality of load operation entries; and
a second array to store a second plurality of load operation entries;
a store array having a plurality of store operation entries;
a first address generation unit coupled to send linear addresses of a first set of load operations to the first array and to send linear addresses of a first set of store operations to the store array;
a second address generation unit coupled to send linear addresses of a second set of load operations to the second array and to send linear addresses of a second set of store operations to the store array;
a translation lookaside buffer (TLB) having a first port coupled to receive the linear addresses of the first set of load operations dispatched from the load array, a second port coupled to receive the linear addresses of the second set of load operations dispatched from the load array, and a third port coupled to receive the linear addresses of the first and the second sets of store operations dispatched from the store array; and
a cache having a first physical address port coupled to receive physical addresses of the first set of load operations, a second physical address port coupled to receive the physical addresses of the second set of load operations, and a third physical address port coupled to receive physical addresses of the first and second sets of store operations.

2. The memory apparatus of claim 1, wherein the cache comprising:
a tag array unit;
a data array unit; and
two write back ports, wherein the data array unit having a plurality of memory banks, each memory bank is dual ported so that two load operations and a store operation can be served in a same clock if the two load operations access different memory banks.

3. The memory apparatus of claim 1, wherein the TLB translates linear addresses to physical addresses.

4. The memory apparatus of claim 1, further comprising:
a first arbiter coupled to select a first load address dispatched from the first array and the first address generation unit;
a second arbiter coupled to select a second load address dispatched from the second array and the second address generation unit; and
a third arbiter coupled to select a store address dispatched from the store array, the first address generation unit and the second address generation unit;

5. The memory apparatus of claim 1, wherein the first array including a first plurality of sections in which each section corresponds to a different processing thread, wherein the second array including a second plurality of sections in which each section corresponds to a different processing thread.

6. A method comprising:
sending linear addresses of a first set of load operations from a first address generation unit to a first array of a load array, wherein the first array comprising a plurality of load operation entries;
sending linear addresses of a second set of load operations from a second address generation unit to a second array of the load array, wherein the second array comprising a second plurality of load operation entries;
sending linear addresses of store operations from the first address generation unit and the second address generation unit to a store array, wherein the store array comprising a plurality of store operation entries;
translating the linear addresses of the first set of load operations to physical addresses of the first set of load operations;
translating the linear addresses of the second set of load operations to physical addresses of the second set of load operations;
translating linear addresses of the store operations to physical addresses of the store operations;
receiving the physical addresses of the first set of load operations from the first array through a first physical address port of a cache;
receiving the physical addresses of the second set of load operations from the second array through a second physical address port of the cache; and
receiving the physical addresses of the store operations from the store array through a third physical address port of the cache.

7. The method of claim 6, wherein the translating from linear addresses to physical addresses are performed by a translation lookaside buffer (TLB);

8. The method of claim 6, wherein:
translating the linear addresses of the first set of load operations into physical addresses of the first set of load operations including receiving the linear addresses of the first set of load operation through a first port of a translation lookaside buffer (TLB);
translating the linear addresses of the second set of load operations into physical addresses of the second set of load operations including receiving the linear addresses of the second set of load operations through a second port of the TLB; and
translating linear addresses of the store operations into physical addresses of the store operations including receiving the linear addresses of the store operations through a third port of the TLB.

9. The method of claim 6, further comprising:
selecting a first load address dispatched from the first array and the first address generation unit using a first arbiter;
dispatching the first load operation address to a translation lookaside buffer (TLB) through a first port of the TLB;
selecting a second load address dispatched from the second array and the second address generation unit using a second arbiter;
dispatching the second load operation to the TLB through a second port of the TLB;
selecting a store address from the store array, the first address generation unit, and the second address generation unit using a third arbiter; and
dispatching the store address to the TLB through a third port of the TLB.

10. The method of claim 6, wherein the first array including a first plurality of sections in which each section corresponds to a different processing thread, wherein the second array including a second plurality of sections in which each section corresponds to a different processing thread.

11. A processor for use in a computer system comprising:
a load array having:
a first array to store a first plurality of load operation entries; and
a second array to store a second plurality of load operation entries;
a store array having a plurality of store operation entries;
a scheduler having:
a first address generation unit coupled to send linear addresses of a first set of load operations to the first array and to send linear addresses of a first set of store operations to the store array;
a second address generation unit coupled to send linear addresses of a second set of load operations to the second array and to send linear addresses of a second set of store operations to the store array; and
a data calculation unit to generate data for store operations;
a translation lookaside buffer (TLB) having a first port coupled to receive the linear addresses of the first set of load operations dispatched from the load array, a second port coupled to receive the linear addresses of the second set of load operations dispatched from the load array, and a third port coupled to receive the linear addresses of the first and the second sets of store operations dispatched from the store array;
a cache having a first physical address port coupled to receive the first load operation, a second physical address port coupled to receive the second load operation, and a third physical address port coupled to receive the first store operation and the second store operation; and
a plurality of registers to receive write back results from the cache.

12. The processor of claim 11, wherein the cache comprising:
a tag array unit;
a data array unit; and
two write back ports, wherein the data array unit having a plurality of memory banks, each memory bank is dual ported so that two load operations and a store operation can be served in a same clock if the two load operations access different memory banks.

13. The processor of claim 11, wherein the TLB translates linear addresses to physical addresses.

14. The processor of claim 11, further comprising:
a first arbiter coupled to select a first load address dispatched from the first array and the first address generation unit;
a second arbiter coupled to select a second load address dispatched from the second array and the second address generation unit; and
a third arbiter coupled to select a store address dispatched from the store array, the first address generation unit and the second address generation unit;

15. The processor of claim 11, wherein the first array including a first plurality of sections in which each section corresponds to a different processing thread, wherein the second array including a second plurality of sections in which each section corresponds to a different processing thread.
